(19) United States
(12) Patent Application Publication
(10) Pub. No.: US 2013/0188625 A1
(43) Pub. Date: Jul. 25, 2013

(54) VLAN POOLING ENHANCEMENT

(71) Applicants: Deepinder Singh Setia, San Ramon, CA (US); Pradeep Iyer, Cupertino, CA (US); Sandeep Unnimadhavan, Bangalore (IN)

(72) Inventors: Deepinder Singh Setia, San Ramon, CA (US); Pradeep Iyer, Cupertino, CA (US); Sandeep Unnimadhavan, Bangalore (IN)

(21) Appl. No.: 13/356,390

(22) Filed: Jan. 23, 2012

(51) Int. Cl. H04W 84/02

(52) U.S. Cl. 370/338

(57) ABSTRACT

The present disclosure discloses a network device and/or method for enhanced VLAN pooling assignments in a wireless network. The disclosed network device receives a message from a wireless client in the wireless network. The network device identifies a virtual local area network (VLAN) based at least on a size of the VLAN and a number of active wireless clients associated with the VLAN. Next, the network device assigns the wireless client to the identified VLAN. In some embodiments, the network device assigns a wireless client to a VLAN if the radio between the number of active wireless clients and the size of the VLAN does not exceed a predetermined value. In some embodiments, the network device assigns a wireless client to a previously assigned VLAN or a VLAN corresponding to an identified home network device, if the wireless client is a roaming client.

### RELATED APPLICATIONS

The present disclosure relates to co-pending U.S. patent application Ser. No. 11/236,006, entitled “VLAN Pooling,” filed on 27 Sep. 2005 by inventors Pradeep Iyer and John Richard Taylor. The contents of the above application are hereby incorporated by reference in their entirety.

### BACKGROUND OF THE INVENTION

The present disclosure relates to wireless network communications. In particular, the present disclosure relates to an enhanced way of assigning network devices to virtual local area networks (VLANs).

Wireless digital networks, such as networks operating under Electrical and Electronics Engineers (IEEE) 802.11 standards, are spreading in their popularity and availability. With such popularity, however, come problems of VLAN assignments. Specifically, network frames from one or more network devices need to reach a group of one or more other network devices in the wireless network. Accordingly, sub networks have been created in order to direct multicast and broadcast transmissions from an access point to a group of wireless network devices.

A virtual local area network (“VLAN”) generally refers to a group of hosts satisfying a common set of requirements that communicate as if they were attached to the same broadcast domain regardless of their physical locations. VLANs provide segmentation services and address issues such as scalability, security, and network management. In addition, VLAN allows for creation of multiple layer 3 networks on the same layer 2 switch, e.g., different VLANs may be configured to obtain their IP addresses from different DHCP servers.

The loads of multiple VLANs in a wireless network can be balanced through a VLAN pool. Conventionally, a station is assigned to a selected VLAN in the VLAN pool based on operations performed on the media access control (MAC) address of the station and the total number of VLANs. Specifically, a source MAC address of a wireless message from a station may undergo logical operations, such as exclusive OR (XOR) operations, to produce a result. Subsequently, a modulo operation (MOD) may be performed on the result and the total number of VLANs to produce a VLAN index that uniquely assigns the station to a particular VLAN in the VLAN pool.

VLAN pooling provides a mechanism for distributing multiple wireless stations to VLANs with fairness and efficiency. However, because VLAN assignments under conventional VLAN pooling are based on the stations' physical addresses and the total number of VLANs in the wireless network, the conventional VLAN pooling does not take into account of the size of the VLANs and the number of active clients on each VLAN. As a result, conventional VLAN pooling may lead to unnecessary extra multicast and/or broadcast traffic in the wireless network.

### BRIEF DESCRIPTION OF THE DRAWINGS

The present disclosure may be best understood by referring to the following description and accompanying drawings that are used to illustrate embodiments of the present disclosure.

FIG. 1A-1B each shows a respective exemplary wireless network environment according to embodiments of the present disclosure.

FIG. 2 is a block diagram illustrating an exemplary network environment used for enhanced VLAN pooling according to embodiments of the present disclosure.

FIG. 3 is a flowchart illustrating an exemplary process of generating base VLAN identifiers in wireless networks according to embodiments of the present disclosure.

FIGS. 4A-4B are block diagrams illustrating exemplary enhanced VLAN pooling assignments according to embodiments of the present disclosure.

FIG. 5 is a flowchart illustrating a process for enhanced VLAN pooling in wireless networks according to embodiments of the present disclosure.

FIG. 6 is a block diagram illustrating a system for enhanced VLAN pooling in wireless networks according to embodiments of the present disclosure.

### DETAILED DESCRIPTION

In the following description, several specific details are presented to provide a thorough understanding. While the context of the disclosure is directed to VLAN assignments in wireless networks, one skilled in the relevant art will recognize, however, that the concepts and techniques disclosed herein can be practiced without one or more of the specific details, or in combination with other components, etc. In other instances, well-known implementations or operations are not shown or described in details to avoid obscuring aspects of various examples disclosed herein. It should be understood that this disclosure covers all modifications, equivalents, and alternatives falling within the spirit and scope of the present disclosure.

### Overview

Embodiments of the present disclosure relate to virtual local area networks (VLANs) in a wireless digital network and, particularly, to an enhanced assignment of network devices to VLANs. The comprehensive solution described herein not only takes into account the size of VLAN as imposed by DHCP service, but also considers other factors such as the number of active clients per VLAN as well as load balancing.

With the solution provided herein, the disclosed network device receives a message from a wireless client in a wireless network; identifies a VLAN based at least on a size of the VLAN and a number of active wireless clients associated with the VLAN; and assigns the wireless client to the identified VLAN.

In some embodiments, the network device assigns the wireless client to the VLAN to reduce multicast traffic in the wireless network. The network device may do so by limiting the number of VLANs associated with the wireless clients.

In some embodiments, the network device also determines whether the message is the first message received from the wireless client or whether the wireless client is a roaming client. If so, the network device may assign the wireless client to the base VLAN if, for example, the ratio between the number of active wireless clients and the size of the VLAN does not exceed a predetermined value, or to the next available VLAN if, for example, the ratio between the number of active wireless clients and the size of the VLAN exceeds the predetermined value. On the other hand, if the message is not the first message received from the wireless client (i.e., one or more access points in the wireless network have received a previous message from the wireless client), or if the wireless client is a roaming client, the network device will assign the wireless client to a VLAN that was previously assigned to the wireless client.

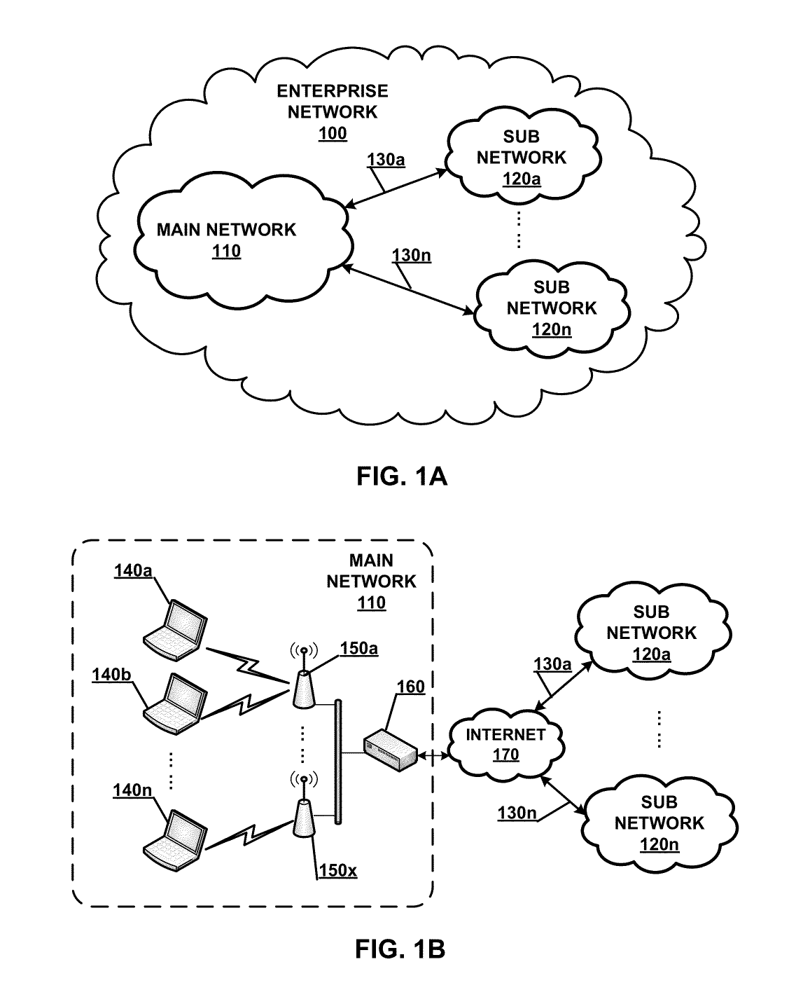

FIGS. 1A-1B show an exemplary wireless digital network environment according to embodiments of the present disclosure. FIG. 1A shows an enterprise network 100, which includes main network 110 and a plurality of sub networks 120a-120n. Main network 110 may operate on a private network including one or more local area networks. The local area networks may be adapted to allow wireless access, thereby operating as a wireless local area network (WLAN). One or more sub networks 120a-120n are remotely located from main network 110 and are in communication via interconnect 130a-130n. According to one embodiment of the invention, communications are established between main network 110 and remote sub networks 120a-120n via interconnects 130a-130n, respectively. It is contemplated, however, that sub networks 120a-120n may be in multicast communications with main network 110.

FIG. 1B illustrates a detailed exemplary embodiment of enterprise network 100 in FIG. 1A. According to this embodiment, main network 110 features a WLAN that comprises a network switch 160 in communication with one or more access points 150a-150x via wired and/or wireless information-carrying medium, which provides either a direct or indirect communication path between access points 150a-150x to network switch 160. Moreover, one or more wireless stations, identified as stations 140a-140n, are in communication with access points 150a-150x over wireless interconnects. Note that an access points 150a-150x may be communicating with stations 140a-140n over multiple communication channels via multiple radios. Moreover, switch 160 is coupled with one or more remote sub networks 120a-120n through Internet 170. In particular, sub networks 120a-120n are coupled to Internet 170 via interconnects 130a-130n.

More specifically, each access point 150a-150x can support bi-directional communications by receiving wireless messages from any or all of the stations 140a-140n within its coverage area and transferring information extracted from the wireless messages over the interconnect to which wireless switch 160 is coupled. Hence, stations 140a-140n are adapted to communicate with and provide information to any associated access points 140a-140n. Also, although not shown, interconnects can provide connectivity for other network resources such as servers, cloud storage, and the like. These network resources are available for restricted or unrestricted access by users of main network 110 and sub network 120a-120n.

### Network Environment for Enhanced VLAN Pooling

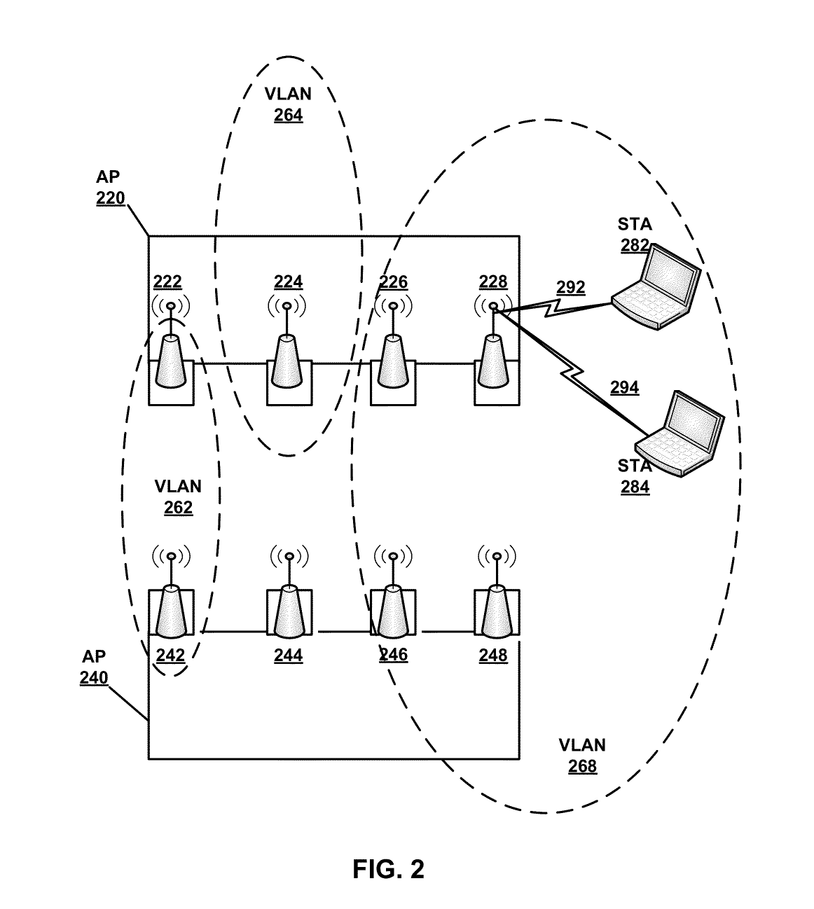

FIG. 2 shows an exemplary network environment used for enhanced VLAN pooling in wireless networks. According to embodiments of the present disclosure, a computer network may be segmented into one or more logical networks. That is, each logical network may include one or more network nodes which communicate with one another as though they reside on the same VLAN even though some of the nodes may be located on different physical LAN segments. As such, each logical grouping of network nodes essentially functions as a virtual local area network. Thus, a VLAN generally defines a broadcast domain in which every node in the VLAN, although not geographically located in the same physical LAN, can communicate with every other node in the VLAN. Hence, broadcast and multicast traffic between VLANs are segregated.

In FIG. 2, a network includes access point 220 and access point 240 for illustration purposes. More network devices may be included in the network environment illustrated in FIG. 2. Illustratively, access point 220 in FIG. 2 has four radios (or bands), namely radio (or band) 222, radio (or band) 224, radio (or band) 226, and radio (or band) 228; and access point 240 has four radios (or bands), namely radio (or band) 242, radio (or band) 244, radio (or band) 246, and radio (or band) 248. In addition, the network illustrated in FIG. 2 includes VLAN 262, VLAN 264, and VLAN 268. Specifically, VLAN 262 is coupled to radio (or band) 222 of access point 220 and to radio (or band) 242 of access point 240; VLAN 264 is coupled to radio (or band) 224 of access point 220; and VLAN 268 is coupled to radios (or bands) 226 and 228 of access point 220 and radios (or bands) 246 and 248 of access point 240. Moreover, a number of wireless client stations are each associated with a radio (or band) of an access point. For example, wireless client stations 282 and 284 may be associated with radio (or band) 228 of access point 220 via wireless link 292.

In some embodiments, an intermediate network device, such as an access point, a router, or a switch associates one or more wireless client stations with a particular VLAN based on which radio of the intermediate network device is coupled to the wireless client stations. For example, the intermediate network device, access point 220, may include radio (or band) 222, radio (or band) 224, and radio (or band) 228, which have been respectively assigned to the VLAN 262, VLAN 264 and VLAN 268. Note that any number of radios (or bands) of the intermediate network device may be associated with the same VLAN. For example, radio (or band) 226 and radio (or band) 228 of access point 220 may be both associated with VLAN 268. Similarly, some radios (or bands) of the intermediate network device may not be associated with any VLAN, e.g., radio (or band) 244 of access point 240. In the illustrated VLAN assignment, because wireless stations 282 and 284 are associated with radio (or band) 228 of access point 220 in FIG. 2, and also because radio (or band) 228 is coupled to VLAN 268, wireless stations 282 and 284 will then be associated with VLAN 268.

Although wireless client stations may be associated with VLANs based on radios, it shall be noted that the wireless client stations may alternatively be associated with VLANs based on other criteria, such as the wireless client station's MAC grouping, IP multicast grouping or other network layer grouping, and/or results of authentication, authorization, and accounting (AAA) services.

In some embodiments, a mobile wireless client station can roam to a different physical location, disassociate with a first radio (or band) at a first access point, and establish association with a second radio (or band) at a second access point. The wireless client station may be assigned to the same or a different VLAN after roaming to the new physical location.

In some embodiments, different radios of an access point may be communicating on the same or different wireless communication channels. For example, in FIG. 2, communications through radios 222 and 224 may be on a first wireless communication channel such as a 2.4 GHz band, whereas communications through radios 226 and 228 may be on a second wireless communication channel such as a 5 Hz band. In such cases, how to assign wireless stations to radios (or bands) and/or VLANs also depend on the wireless communication channel(s) that a wireless station is capable of communicating on.

In some embodiments, one or more VLANs will be grouped into a VLAN pool. A wireless station may be assigned to a VLAN in a VLAN pool based on one or more of the following considerations, which include but are not limited to, load balancing, efficiency of multicast traffic delivery, fairness to wireless client stations, etc.

### Enhanced VLAN Pooling

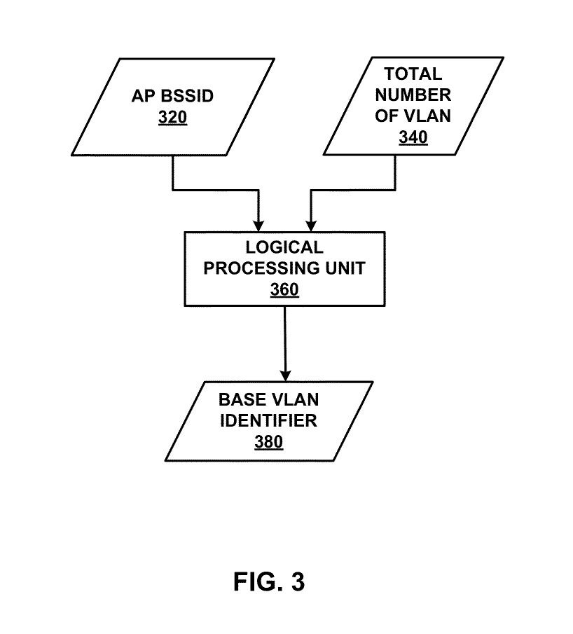

FIG. 3 is a flowchart illustrating an exemplary process of generating base VLAN identifiers in wireless networks. According to this embodiment, logical processing unit 360 performs logical operations on at least a unique physical identifier for a radio of an access point, e.g., an access point's corresponding basic service set identifier (“BSSID”) 320 and total number of VLAN 340 to generate base VLAN identifier 380.

In some embodiments, logical operations such as XOR operations may be performed on a bitwise or multi-bit basis (e.g., byte, word, etc.). As an example, XOR operations may be performed on the BSSID of an access point on a byte-by-byte basis. As another example, XOR operations may be performed in a chain on successive bytes forming the BSSID of an access point. For instance, a first byte b[0] is XOR'ed with a second byte b[1] to generate a first resulting byte; the first resulting byte is further XOR'ed with a third byte b[2] to generate a second resulting byte; the second resulting byte is further XOR'ed with a fourth byte b[3] to generate a third resulting byte; and so on.

In some embodiments, logical processing unit 360 performs an arithmetic operation on both an access point's BSSID 320 and a total number of VLANs in the VLAN pool. For example, logical processing unit 360 can perform a modulo (MOD) operation as set forth in the equation: (Base VLAN identifier)=(AP BSSID)MOD(Total number of VLAN). The arithmetic operation performed by logic processing unit 360 produces base VLAN identifier 380, which is equivalent to a remainder of the access point's BSSID divided by the total number of VLANs.

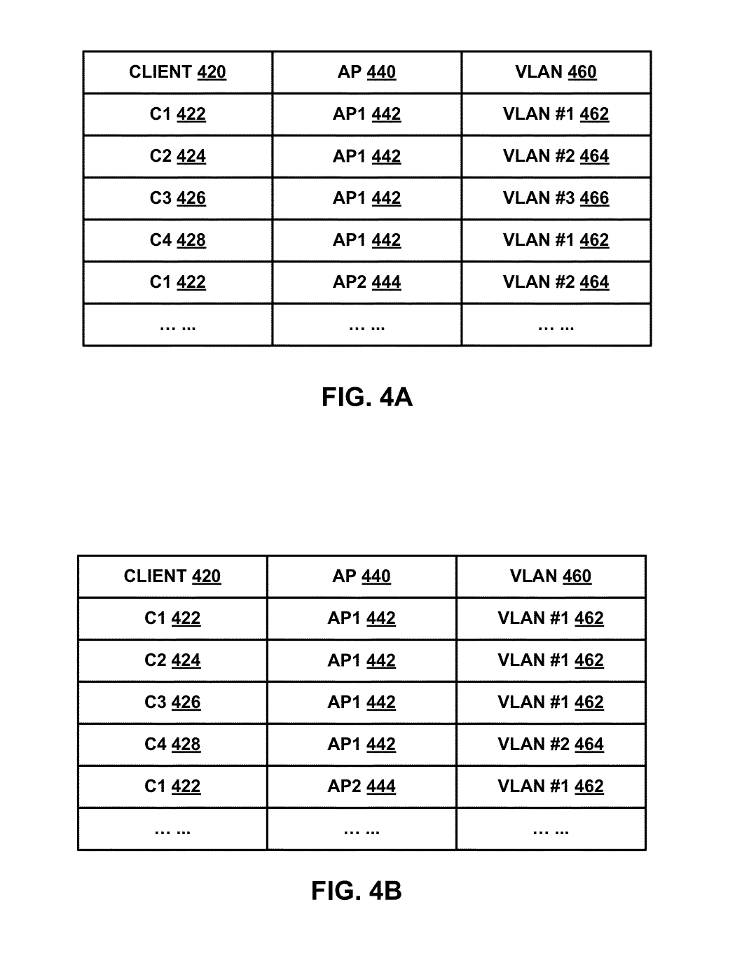

FIGS. 4A-4B are block diagrams illustrating exemplary VLAN pooling assignments. VLAN assignment table illustrated in FIGS. 4A-4B can be used by access points to route all incoming multicast and/or broadcast messages from a wireless station to other network devices in the same VLAN. In the examples illustrated in FIGS. 4A-4B, the network system presumably includes four wireless client stations C1 422, C2 424, C3 426, and C4 428, two access points AP1 442 and AP2 444, and three VLANs VLAN #1 462, VLAN #2 464, and VLAN #3 466. Note that FIGS. 4A-4B only illustrates two alternative embodiments of VLAN pooling assignments. Other VLAN pooling assignments in the same network environments may be used without departing from the spirit of the present disclosure. Moreover, the network environment may include any number of wireless stations, access points and/or other network devices, and VLANs and/or other hardware/software groupings.

FIG. 4A shows one embodiment of VLAN pooling assignments. According to this embodiment, client 420, access point 440, and VLAN 460 are listed as three columns in the VLAN assignment table to show the mappings among the wireless client stations, access points, and VLANs. Specifically, when wireless client C1 422 is associated with access point AP1 442, wireless client C1 422 is assigned to VLAN #1 462; when wireless client C2 424 is associated with access point AP1 442, wireless client C2 424 is assigned to VLAN #2 464; when wireless client C3 is associated with access point AP1 442, wireless client C3 is assigned to VLAN #3 466. Each VLAN in the network has been assigned to one wireless client so far, and therefore VLAN pooling assignment illustrated in FIG. 4A improves load balancing and favors fairness among VLANs. Next, assuming wireless client C4 428 is associated with access point AP1 442, wireless client C4 428 may be assigned to any VLAN according to the fairness principle. In this assignment, it will be assigned to VLAN #1 462 based on a round robin scheme. Likewise, when C1 422 subsequently roams from AP1 442 to AP2 444, C1 422 is assigned to VLAN 32 464 also based on the round robin scheme.

Although VLAN assignments in FIG. 4A enhances load balancing and fairness, it could create extra multicast and/or broadcast traffic. Moreover, the VLAN assignments in accordance to FIG. 4A do not consider the size of the VLANs and the active clients in each VLAN. In the alternative embodiment illustrated in FIG. 4B, client 420, access point 440, and VLAN 460 are listed as three columns in the VLAN assignment table to show the mappings among the wireless client stations, access points, and VLANs. Specifically, in this embodiment, when wireless client C1 422 is associated with access point AP1 442, wireless client C1 422 is assigned to VLAN #1 462. Moreover, when wireless clients C2 424 and C3 426 are associated with access point AP1 442, wireless clients C2 424 and C3 426 are also assigned to VLAN #1 462. All three wireless clients C1 422, C2 424, and C3 426 have been assigned to a single VLAN, i.e., VLAN #1 462 in the network, and therefore VLAN pooling assignment illustrated in FIG. 4B reduces the multicast and/or broadcast traffic among all VLANs in the network. This is because, rather than multicast or broadcast messages from C1 422 to VLAN #1 462, messages from C2 424 to VLAN #2 464, and messages from C3 426 to VLAN #3 466 as in the VLAN assignments illustrated in FIG. 4A, VLAN assignments illustrated in FIG. 4B allow for multicasting or broadcasting messages from all three clients C1 422, C2 424, and C3 426 to a single VLAN #1 462. Next, assuming that wireless client C4 428 is associated with access point AP1 442 and that the number of wireless clients associated with VLAN #1 462 has exceeded a predetermined threshold, then wireless client C4 428 will be assigned to another VLAN, e.g. VLAN #2 464 as shown in FIG. 4B.

Note that in some embodiments, whenever possible, upon detecting that a client is a roaming client, the roaming client will be assigned to the same VLAN as it was assigned to prior to associating with another access point. For example, when C1 422 subsequently roams from AP1 442 to AP2 444, C1 422 is assigned to VLAN #1 462, because C1 422 was assigned to VLAN #1 462 while C1 was being associated with AP1 442 prior to associating with AP2 444.

In one embodiment, AP1 442 and AP2 444 are both coupled to the same network controller, and C1 422 roams from AP1 442 to AP2 444. In such scenario of intra-controller roaming, the controller maintains client C1 422's session state which indicates whether client C1 422 is a roaming client. In an alternative embodiment, AP1 442 and AP2 444 are coupled to two different network controllers, and C1 422 roams from AP1 442 to AP2 444. In such scenario of inter-controller roaming, the network controller coupled to AP2 444 can perform a bridge lookup to determine whether a bridge entry exists on the network controller. If so, the same VLAN as identified in the bridge entry will be assigned for the client C1 422 when C1 422 is associated with AP2 444. In another alternative embodiment, AP1 442 and AP2 444 are not coupled to any network controller, or are coupled to one or more virtual controllers that reside on one or more access points which may or may not include AP1 442 and/or AP2 444. In such scenario of controller-less roaming, AP2 444 will send a broadcast request upon receiving an association request from client C1 422 to inquire whether any access points are aware of C1 422. If so, AP2 444 can determine that C1 422 as a roaming client.

In some embodiments, a network controller can monitor the amounts of time that a client is associated with each access point in the network. Furthermore, the network controller can identify an access point that the client has been associated with most of the time during a recent predetermined time period as the home access point for the client. The length of the predetermined time period can be configurable by a network administrator. The network controller also may keep a table to track the home access point for each associated clients. In one embodiment, when a client connects to a first access point in the network, the controller performs a lookup in the table to determine the home access point for the client. If the home access point is successfully identified for the client and is different from the first access point that the client is associated with, the client will be assigned to the VLAN corresponding to the home access point rather than the first access point that the client is associated with. In one embodiment, when a client roams to associating with a second access point in the network, a home access point will be determined as described above. In this embodiment, the client will be assigned to the VLAN corresponding to the home access point, rather than the access point that the client was associated with immediately prior to roaming to the second access point. In some embodiments, when the wireless client is not a roaming client, the wireless client will be assigned to the base VLAN assigned to the basic service set identifier (BSSID) of the access point with which the wireless client associates.

### Enhanced VLAN Pooling Process

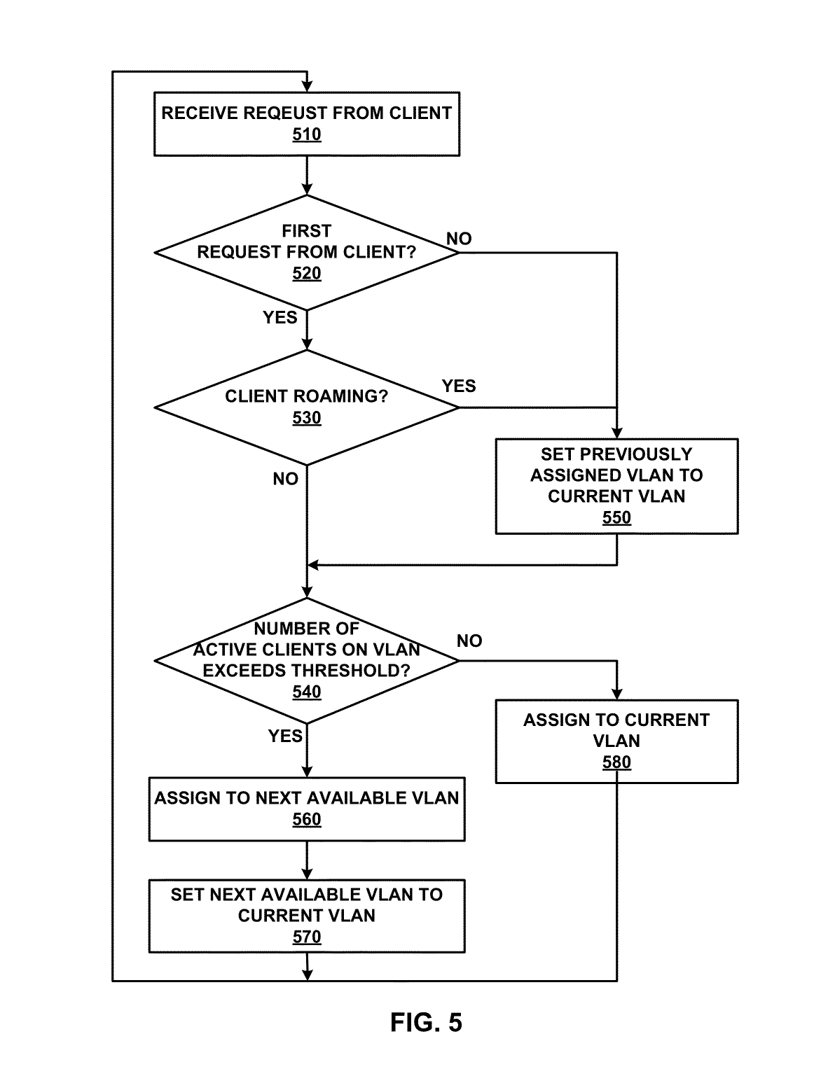

FIG. 5 is a flowchart illustrating the process of enhanced VLAN pooling. During operation, a network device receives a request, such as an association request, from a client (operation 510). The network device then determines whether the request is the first request received from the client (operation 520). If so, the network device further determines whether the client is a roaming client (operation 530).

In response to the request not being the first request from the client (e.g., when a client, which was previously associated with the network device and roamed to associate with a different network device, returns to associate with the same network device), or in response to the client is a roaming client (e.g., the client was previously associated with another network device in the network), the network device will identify the VLAN that was previously assigned to the client, and set the client VLAN to be the identified VLAN (operation 550).

Next, the network device determines whether the number of the active clients on the base VLAN exceeds a predetermined threshold (operation 540). If not, the network device assigns the client to the base VLAN (operation 580). Otherwise, the network device assigns the client to the next available VLAN (operation 560), and set the next available VLAN to be the base VLAN (operation 570). Note that the base VLAN uniquely identifies a VLAN from the VLAN pool that is waiting to be assigned a new client.

### Enhanced VLAN Pooling System

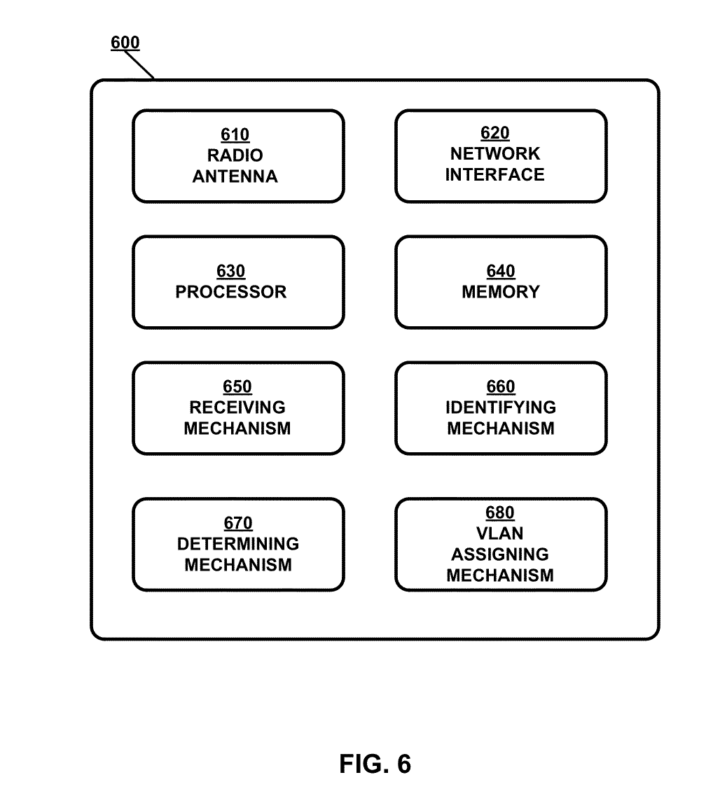

FIG. 6 is a block diagram illustrating a system for an enhanced VLAN pooling according to embodiments of the present disclosure.

Operating as a node in a wireless digital network, network device 600 includes at least one or more radio antennas 610 capable of either transmitting or receiving radio signals or both, a network interface 620 capable of communicating to a wired or wireless network, a processor 630 capable of processing computing instructions, and a memory 640 capable of storing instructions and data. Moreover, network device 600 further includes a receiving mechanism 650, an identifying mechanism 660, a determining mechanism 670, and a VLAN assigning mechanism 680, all of which are coupled to processor 630 and memory 640 in network device 600. Network device 600 may be used as a client system, or a server system, or may serve both as a client and a server in a distributed or a cloud computing environment.

Radio antenna 610 may be any combination of known or conventional electrical components for receipt of signaling, including but not limited to, transistors, capacitors, resistors, multiplexers, wiring, registers, diodes or any other electrical components known or later become known.

Network interface 620 can be any communication interface, which includes but is not limited to, a modem, token ring interface, Ethernet interface, wireless IEEE 802.11 interface, cellular wireless interface, satellite transmission interface, or any other interface for coupling network devices.

Processor 630 can include one or more microprocessors and/or network processors. Memory 640 can include storage components, such as, Dynamic Random Access Memory (DRAM), Static Random Access Memory (SRAM), etc. In some embodiments, memory 640 stores VLAN assignments, for example, in a table. An exemplary VLAN assignment table may include three columns to show the mappings among the wireless client stations, access points, and VLANs.

Specifically, in one embodiment, the VLAN pooling assignment is based on a round robin scheme. VLAN assignment in accordance with this embodiment improves load balancing and favors fairness among VLANs. In another embodiment, the VLAN pooling assignment considers the size of the VLANs and the active clients in each VLAN, for example, by assigning wireless client stations to a base VLAN as long as the number of active wireless client stations associated with an access point does not exceed a predetermined threshold value relative to the size of the VLAN. Such VLAN assignment reduces the multicast and/or broadcast traffic among all VLANs in the network. This is because, rather than multicasting or broadcasting messages from multiple wireless clients in separate multicast domains, the VLAN assignment allows for multicasting or broadcasting messages from multiple wireless clients to a single VLAN and thus a single multicast domain.

Receiving mechanism 650 receives one or more network messages via network interface 620 or radio antenna 610. The received network messages may include, but are not limited to, requests and/or responses, beacon frames, management frames, control path frames, and so on, as described in the present disclosure.

Identifying mechanism 660 identifies a VLAN based at least on a size of the VLAN and a number of active wireless clients associated with the VLAN. In some embodiments, identifying mechanism 660 is further adapted to identify a VLAN that has been previously assigned to a wireless client. Specifically, in one embodiment, identifying mechanism 660 performs a bridge lookup to determine whether a bridge entry exists on a network controller for a wireless client. If such bridge entry exists, identifying mechanism 660 will retrieve a VLAN associated with the bridge entry, and identify the retrieved VLAN as the VLAN previously assigned to the wireless client.

Determining mechanism 670, according to one embodiment, determines whether the message is a first message received from the wireless client. That is, whether the client has sent any previous request, such as an association or authentication request, to network device 600 or another network device in the wireless network after starting up. According to another embodiment, determining mechanism 670 determines whether the wireless client is a roaming client.

In some embodiments, determining mechanism 670 can detect that the wireless client is a roaming client, and further determine the VLAN that the wireless client is assigned to while associated with another network device prior to associating with network device 600.

Specifically, in intra-controller roaming scenarios, a network controller maintains the wireless client's session state, which indicates whether the wireless client is a roaming client. Alternatively, in inter-controller roaming scenarios, the network controller coupled to an access point that the wireless client is associated with can perform a bridge lookup to determine whether a bridge entry exists on another network controller. If so, the wireless client will be determined as a roaming client. Furthermore, in controller-less roaming scenarios in which none of the access points is coupled to any network controller or virtual controllers (which reside on one or more access points), the access point that the wireless client is associated with can send a multicast or broadcast request upon receiving an association request from the wireless client to inquire whether any other access points in the wireless network are aware of the wireless client. If the access point receives a response indicating that one or more other access points in the network are aware of the wireless client, the wireless client will be identified as a roaming client.

In some embodiments, determining mechanism 670 also determines whether a ratio between the number of active wireless clients and the size of the VLAN exceeds a predetermined value. Moreover, if the radio between the number of active wireless clients and the size of the VLAN does not exceed a predetermined value, identifying mechanism 660 will identify a base VLAN as the VLAN to be assigned to the wireless client. Otherwise, if the radio between the number of active wireless clients and the size of the VLAN exceeds the predetermined value, identifying mechanism 660 identifies a next available VLAN as the VLAN to be assigned to the wireless client. Note that the radio between the number of active wireless clients associated with the next available VLAN and the size of the next available VLAN does not exceed the predetermined value.

VLAN assigning mechanism 680 generally assigns wireless clients to identified VLANs. In some embodiments, VLAN assigning mechanism assigns a wireless client to a VLAN as identified by identifying mechanism 660 to reduce multicast and/or broadcast traffic in the wireless network, for example, by limiting the number of VLANs associated with the wireless clients. In some embodiments, VLAN assigning mechanism 680 assigns the VLAN based on the size of the VLAN and the number of active wireless clients associated with the VLAN, if (1) the message is a first message received from the wireless client, and (2) the client is not a roaming client. In other embodiments, VLAN assigning mechanism 680 assigns the wireless device to a VLAN that was previously assigned to the wireless client, if the message is not a first message received from the wireless client (i.e., receiving mechanism 650 or another network device such as an access point in the wireless network has received a previous message from the wireless client), or the wireless client is a roaming client.

In some embodiments, identifying mechanism 660 can identify an access point that the client has been associated with most of the time during a recent predetermined time period as the home access point for the client. The length of the predetermined time period can be configurable by a network administrator. Furthermore, there may be a table kept in memory 640 to track the home access point for each associated clients. In one embodiment, when a client connects to a first access point in the network, determining mechanism 670 performs a lookup in the table to determine the home access point for the client. If the home access point is successfully identified for the client and is different from the first access point that the client is associated with, VLAN assigning mechanism 680 will assign the client to the VLAN corresponding to the home access point rather than the first access point that the client is associated with. In one embodiment, when a client roams to associating with a second access point in the network, determining mechanism 670 will look up the table in memory 640 and determine a home access point. In this embodiment, VLAN assigning mechanism 680 will assign the client to the VLAN corresponding to the basic service set identifier (BSSID) associated with the home access point, rather than the access point that the client was associated with immediately prior to roaming to the second access point. In some embodiments, when determining mechanism 670 determines that the wireless client is not a roaming client, VLAN assigning mechanism 680 will assign the wireless client to the base VLAN assigned to the basic service set identifier (BSSID) of the access point with which the wireless client associates.

Receiving mechanism 650, identifying mechanism 660, determining mechanism 670, and VLAN assigning mechanism 680 collectively operation with each other to accomplish enhanced VLAN pooling assignments.

According to embodiments of the present disclosure, network services provide by managed network device 600 include, but are not limited to, an Institute of Electrical and Electronics Engineers (IEEE) 802.1x authentication to an internal and/or external Remote Authentication Dial-In User Service (RADIUS) server; an MAC authentication to an internal and/or external RADIUS server; a built-in Dynamic Host Configuration Protocol (DHCP) service to assign wireless client devices IP addresses; an internal secured management interface; Layer-3 forwarding; Network Address Translation (NAT) service between the wireless network and a wired network coupled to the network device; an internal and/or external captive portal; an external management system for managing the network devices in the wireless network; etc.

The present disclosure may be realized in hardware, software, or a combination of hardware and software. The present disclosure may be realized in a centralized fashion in one computer system or in a distributed fashion where different elements are spread across several interconnected computer systems coupled to a network. A typical combination of hardware and software may be an access point with a computer program that, when being loaded and executed, controls the device such that it carries out the methods described herein.

The present disclosure also may be embedded in non-transitory fashion in a computer-readable storage medium, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

As used herein, “network device” generally includes a station (e.g., any data processing equipment such as a computer, cellular phone, personal digital assistant, tablet devices, etc.), an access point, data transfer devices (such as network switches, routers, controllers, etc.) or the like.

As used herein, an “interconnect” is generally defined as a communication pathway established over an information-carrying medium. The “interconnect” may be a wired interconnect, wherein the medium is a physical medium (e.g., electrical wire, optical fiber, cable, bus traces, etc.), a wireless interconnect (e.g., air in combination with wireless signaling technology) or a combination of these technologies.

As used herein, “information” is generally defined as data, address, control, management (e.g., statistics) or any combination thereof. For transmission, information may be transmitted as a message, namely a collection of bits in a predetermined format. One type of message, namely a wireless message, includes a header and payload data having a predetermined number of bits of information. The wireless message may be placed in a format as one or more packets, frames or cells.

As used herein, “access point” (AP) generally refers to receiving points for any known or convenient wireless access technology which may later become known. Specifically, the term AP is not intended to be limited to IEEE 802.11-based APs. APs generally function to allow wireless devices to connect to a wired network via various communications standards.

As used herein, “wireless local area network” (WLAN) generally refers to a communications network links two or more devices using some wireless distribution method (for example, spread-spectrum or orthogonal frequency-division multiplexing radio), and usually providing a connection through an access point to the Internet; and thus, providing users with the mobility to move around within a local coverage area and still stay connected to the network.

As used herein, the term “mechanism” generally refers to a component of a system or device to serve one or more functions, including but not limited to, software components, electronic components, mechanical components, electro-mechanical components, etc.

As used herein, the term “embodiment” generally refers an embodiment that serves to illustrate by way of example but not limitation.

It will be appreciated to those skilled in the art that the preceding examples and embodiments are exemplary and not limiting to the scope of the present disclosure. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of the present disclosure.

While the present disclosure has been described in terms of various embodiments, the present disclosure should not be limited to only those embodiments described, but can be practiced with modification and alteration within the spirit and scope of the appended claims. The description is this to be regarded as illustrative rather than limiting.

What is claimed is:

1. A method comprising:
receiving, at a network device in a wireless network, a message from a wireless client;
identifying, by the network device, a virtual local area network (VLAN) based at least on a size of the VLAN and a number of active wireless clients associated with the VLAN; and
assigning, by the network device, the wireless client to the identified VLAN.

2. The method of claim 1, wherein assigning the wireless client to the identified VLAN reduces multicast traffic in the wireless network.

3. The method of claim 2, wherein identifying the VLAN further comprises:
determining, by the network device, whether the message is a first message received from the wireless client;
determining, by the network device, whether the wireless client is a roaming client; and
in response to the message being the first message received from the wireless client and the client not being a roaming client, assigning the VLAN based on the size of the VLAN and the number of active wireless clients associated with the VLAN.

4. The method of claim 3, further comprises:
in response to the client not being the roaming client, assigning the wireless client to a base VLAN assigned to a basic service set identifier (BSSID) associated with the network device.

5. The method of claim 3, further comprises:
determining, by the network device, a home network device based on the amounts of time that the wireless client is associated with network devices in the network during a recent predetermined time period; and
in response to the client not being the roaming client, assigning the wireless client to the VLAN corresponding to a BSSID associated with the home network device.

6. The method of claim 3, further comprising:
detecting, by the network device, that the wireless client is a roaming client;
determining, by the network device, the VLAN that the wireless client is assigned to while associated with another network device prior to associating with the network device; and
in response to the message not being the first message received from the wireless client or the client being the roaming client, assigning the wireless client to the VLAN which was previously assigned to the wireless client.

7. The method of claim 3, wherein determining whether the wireless client is the roaming client comprises one or more of:
performing a bridge lookup to determine whether a bridge entry exists on a network controller for the wireless client;
in response to the bridge entry existing, retrieving a VLAN associated with the bridge entry; and
identifying the retrieved VLAN as the VLAN previously assigned to the wireless client.

8. The method of claim 1, wherein identifying the VLAN based at least on a size of the VLAN and a number of active wireless clients associated with the VLAN comprises:
determining, by the network device, whether a ratio between the number of active wireless clients and the size of the VLAN exceeds a predetermined value;
in response to the ratio not exceeding the predetermined value, identifying a base VLAN as the VLAN to be assigned to the wireless client; and
in response to the ratio exceeding the predetermined value, identifying a next available VLAN as the VLAN to be assigned to the wireless client.

9. A network device comprising:
a processor;
a memory;
a receiving mechanism coupled to the processor, the receiving mechanism to a message from a wireless client;
an identifying mechanism coupled to the processor, the identifying mechanism to identify a virtual local area network (VLAN) based at least on a size of the VLAN and a number of active wireless clients associated with the VLAN; and
a VLAN assigning mechanism coupled to the processor, the VLAN assigning mechanism to assign the wireless client to the identified VLAN.

10. The network device of claim 9, wherein the VLAN assigning mechanism assigns the wireless client to the identified VLAN to reduce multicast traffic in the wireless network.

11. The network device of claim 10, further comprises:
a determining mechanism coupled to the processor, the determining mechanism to determine whether the message is a first message received from the wireless client,
wherein the determining mechanism further determines whether the wireless client is a roaming client; and
wherein the VLAN assigning mechanism assigns the VLAN based on the size of the VLAN and the number of active wireless clients associated with the VLAN in response to the message being the first message received from the wireless client and the client not being a roaming client.

12. The network device of claim 11,
wherein the VLAN assigning mechanism assigns the wireless client to a base VLAN assigned to a BSSID associated with the network device in response to the client not being the roaming client.

13. The network device of claim 11,
wherein the determining mechanism determines a home network device based on the amounts of time that the wireless client is associated with network devices in the network during a recent predetermined time period; and
wherein the VLAN assigning mechanism assigns the wireless client to the VLAN corresponding to a BSSID associated with the home network device in response to the client not being the roaming client.

14. The network device of claim 11, wherein the determining mechanism further to:
detect that the wireless client is a roaming client; and
determine the VLAN that the wireless client is assigned to while associated with another network device prior to associating with the network device; and
wherein the VLAN assigning mechanism assigns the wireless client to the VLAN which was previously assigned to the wireless client in response to the message not being the first message received from the wireless client or the client being the roaming client.

15. The network device of claim 11, wherein identifying mechanism further accomplishes one or more of:
performing a bridge lookup to determine whether a bridge entry exists on a network controller for the wireless client;
retrieving a VLAN associated with the bridge entry in response to the bridge entry existing; and
identifying the retrieved VLAN as the VLAN previously assigned to the wireless client.

16. The network device of claim 9,
wherein the determining mechanism further determines whether a ratio between the number of active wireless clients and the size of the VLAN exceeds a predetermined value;
wherein the identifying mechanism identifies a base VLAN as the VLAN to be assigned to the wireless client in response to the ratio not exceeding the predetermined value; and
wherein the identifying mechanism identifies a next available VLAN as the VLAN to be assigned to the wireless client in response to the ratio exceeding the predetermined value.

17. A non-transitory computer-readable storage medium storing embedded instructions that are executed by one or more mechanisms implemented within a network device to perform a plurality of operations comprising:
receiving a message from a wireless client in a wireless network;
identifying a virtual local area network (VLAN) based at least on a size of the VLAN and a number of active wireless clients associated with the VLAN; and
assigning the wireless client to the identified VLAN.

18. The non-transitory computer-readable storage medium of claim 17, wherein assigning the wireless client to the identified VLAN reduces multicast traffic in the wireless network.

19. The non-transitory computer-readable storage medium of claim 18, wherein identifying the VLAN further comprises:
determining whether the message is a first message received from the wireless client;
determining whether the wireless client is a roaming client; and
assigning the VLAN based on the size of the VLAN and the number of active wireless clients associated with the VLAN in response to the message being the first message received from the wireless client and the client not being a roaming client.

20. The non-transitory computer-readable storage medium of claim 19, wherein the plurality of operations further comprises:
in response to the client not being the roaming client, assigning the wireless client to a base VLAN assigned to a basic service set identifier (BSSID) associated with the network device.

21. The non-transitory computer-readable storage medium of claim 19, wherein the plurality of operations further comprises:
determining a home network device based on the amounts of time that the wireless client is associated with network devices in the network during a recent predetermined time period; and
in response to the client not being the roaming client, assigning the wireless client to the VLAN corresponding to a BSSID associated with the home network device.

22. The non-transitory computer-readable storage medium of claim 19, wherein the plurality of operations further comprises:
detecting that the wireless client is a roaming client;
determining the VLAN that the wireless client is assigned to while associated with another network device prior to associating with the network device; and
in response to the message not being the first message received from the wireless client or the client being the roaming client, assigning the wireless client to the VLAN which was previously assigned to the wireless client.

23. The non-transitory computer-readable storage medium of claim 19, wherein determining whether the wireless client is the roaming client comprises one or more of:
performing a bridge lookup to determine whether a bridge entry exists on a network controller for the wireless client;
in response to the bridge entry existing, retrieving a VLAN associated with the bridge entry; and
identifying the retrieved VLAN as the VLAN previously assigned to the wireless client.

24. The non-transitory computer-readable storage medium of claim 17, wherein identifying the VLAN based at least on a size of the VLAN and a number of active wireless clients associated with the VLAN comprises:
determining whether a ratio between the number of active wireless clients and the size of the VLAN exceeds a predetermined value;
identifying a base VLAN as the VLAN to be assigned to the wireless client in response to the ratio not exceeding the predetermined value; and
identifying a next available VLAN as the VLAN to be assigned to the wireless client in response to the ratio exceeding the predetermined value.
